(19) United States
(12) Patent Application Publication
(10) Pub. No.: US 2026/0265009 A1
(43) Pub. Date: Sep. 10, 2026

(54) PRINTER AND CONTROL METHOD FOR A PRINTER

(71) Applicant: Toshiba Tec Kabushiki Kaisha, Tokyo (JP)

(72) Inventors: Kiyotaka NIHASHI, Mishima Shizuoka (JP); Yuji KAWAMORITA, Mishima Shizuoka (JP)

(21) Appl. No.: 19/387,196

(22) Filed: Nov. 12, 2025

(30) Foreign Application Priority Data
Mar. 6, 2025 (JP) 2025-035085

(51) Int. Cl. B65H 7/04; B65H 35/00

(52) U.S. Cl. CPC B65H 7/04; B65H 35/008; B65H 2402/441; B65H 2553/00

(57) ABSTRACT

According to an embodiment, a printer detects a sheet of paper in accordance with power being turned on, and outputs the sheet of paper from a paper output port by a first predetermined amount in accordance with detection of the sheet of paper. The printer detects opening/closing of a cover in accordance with undetection of the sheet of paper. Further, the printer outputs the sheet of paper from the paper output port by a second predetermined amount shorter than the first predetermined amount in accordance with detection of that the cover has transitioned from an opened state to a closed state.

### CROSS-REFERENCE TO RELATED APPLICATIONS

This application is based upon and claims the benefit of priority from the prior Japanese Patent Application No. 2025-035085, filed on Mar. 6, 2025, the entire contents of which are incorporated herein by reference.

### FIELD

An embodiment to be described here generally relates to a printer and a control method for a printer.

### BACKGROUND

In the past, printers for printing receipts or coupons have been used by being connected to or mounted on devices such as Point of Sales (POS) terminals, self-checkout devices, and accounting devices of semi-self-checkout systems. Some of such printers perform, when the printer's cover is closed after rolled paper (hereinafter, also referred to as a "sheet of paper") is set, an operation (auto-feed and cut) of feeding the sheet of paper by a predetermined amount and then cutting the leading edge portion of the sheet of paper.

The above-mentioned auto-feed and cut allows the position of the leading edge of the cut sheet of paper to be aligned with a predetermined position. It also allows the leading edge of the cut sheet of paper to be neatly aligned. Note that the leading edge portion cut by the auto-feed and cut is fed out of the paper output port such that it protrudes while the printer's cover is closed. Therefore, the user can easily remove the cut portion by holding the holding part protruding from the paper output port.

There are also printers that perform auto-feed and cut when the power source is turned on, i.e., when the power switch transitions from the OFF state to the ON state. However, when the power source of the printer is turned on, the state of the sheet of paper before the power source is turned on is uncertain. Therefore, performing auto-feed and cut as when opening/closing the printer's cover could potentially make it difficult to easily remove the cut portion.

### BRIEF DESCRIPTION OF THE DRAWINGS

FIG. 1 is a diagram showing a schematic configuration of a printer according to an embodiment.

FIG. 2 is a diagram showing an example of the hardware configuration of the printer according to the embodiment.

FIG. 3 is a diagram showing an example of the appearance of the printer according to the embodiment.

FIG. 4 is a diagram showing an example of the printer shown in FIG. 3 with the cover opened.

FIG. 5 is a top view of the printer with the cover closed according to the embodiment.

FIG. 6 is an enlarged view of the cross section of the printer shown in FIG. 5 taken along the arrow C-C.

FIG. 7 is a top view of the printer with the cover opened.

FIG. 8 is an enlarged view of the cross section of the printer shown in FIG. 7 taken along the arrow D-D.

FIG. 9 is an enlarged view of the cross section of the printer shown in FIG. 5 taken along the arrow E-E.

FIG. 10 is an enlarged view of the cross section of the printer shown in FIG. 5 taken along the arrow F-F.

FIG. 11 is a flowchart showing an example of the operation flow of auto-feed and cut performed by the printer according to the embodiment.

FIG. 12 is a diagram showing an example of the state where, after the power source of the printer according to the embodiment is turned ON, a sheet of paper is conveyed and cut by a cutter.

FIG. 13 is a diagram showing an example of the state where, after rolled paper is loaded, a sheet of paper is conveyed and cut by the cutter, in the embodiment.

### DETAILED DESCRIPTION

According to an embodiment, a printer prints on a sheet of paper housed inside a main body having an openable/closable cover and outputs the sheet of paper from an output port of the main body. The printer includes a paper detection device, a conveying mechanism, a cover detection device, and a controller. The paper detection device detect presence or absence of the sheet of paper housed inside the main body. The conveying mechanism transports the sheet of paper in a direction in which the sheet of paper is output from the discharge port. The cover detection device detects an opened/closed state of the cover. The controller is configured to determine whether or not a sheet of paper is detected by the paper detection device when the power source is turned on. The controller is further configured to control, where a sheet of paper is detected as a result of the determination, the conveying mechanism to execute a first output operation of outputting the sheet of paper from the output port by a first predetermined amount. The controller is further configured to control, where the sheet of paper is not detected as a result of the determination and the cover detection device detects that the cover has transitioned from the opened state to the closed state after the determination, the conveying mechanism to execute a second output operation of outputting the sheet of paper from the output port by a second predetermined amount. The second predetermined amount is shorter than the first predetermined amount.

Hereinafter, an embodiment will be described in detail with reference to the drawings. In the drawings, the same reference symbols will denote the same or similar portions. Note that the following description does not limit this embodiment.

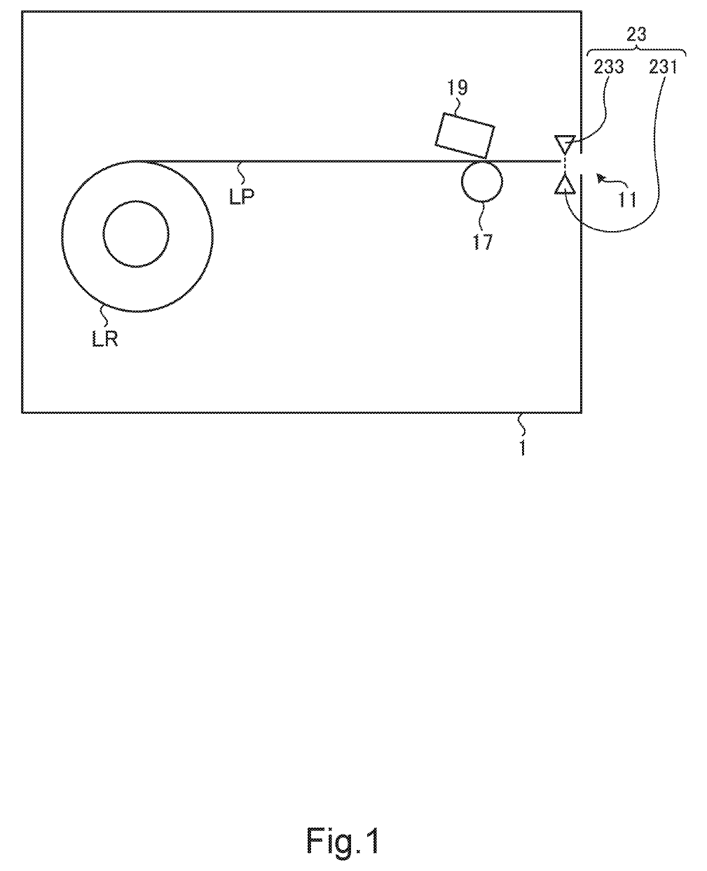

FIG. 1 is a diagram showing a schematic configuration of a printer 1 according to an embodiment. The overview of the printer 1 will be described below with reference to FIG. 1. The printer 1 corresponds to a thermal printer. The printer 1 is used, for example, as a receipt printer for printing receipts.

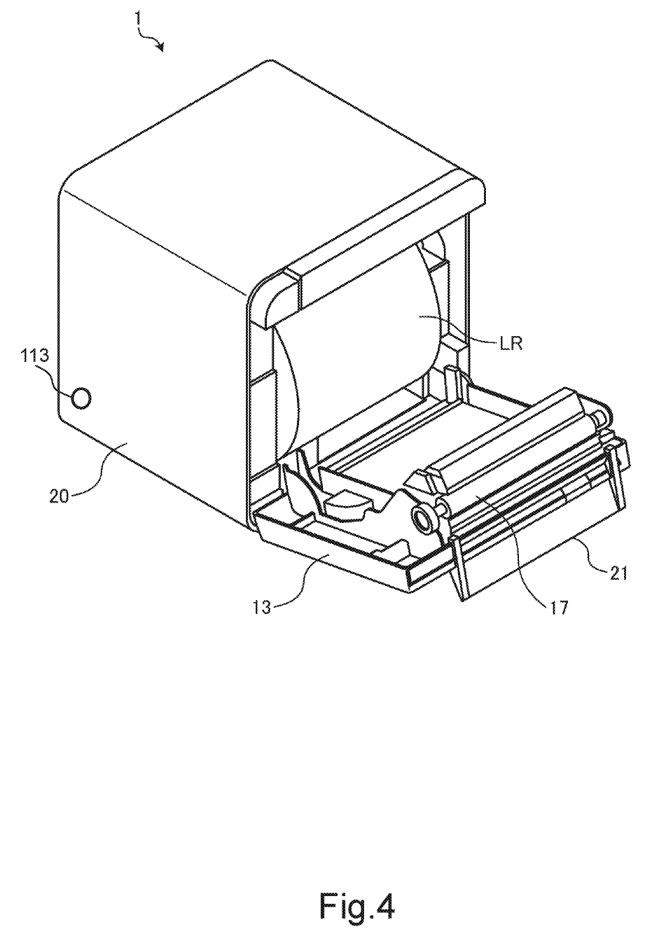

The printer 1 houses, inside a main body 20, rolled paper LR with which the main body 20 can be replenished when a cover 13 (see FIG. 4) is in the opened state. The rolled paper LR is a sheet of paper LP, which is an example of printing paper, wound into a roll. The printer 1 prints on the sheet of paper LP while drawing the sheet of paper LP from the rolled paper LR. The printer 1 includes a paper output port 11, a platen roller 17, a print head 19, and a cutter 23. The paper output port 11 outputs the sheet of paper LP cut by the cutter 23.

The print head 19 is an example of a printed unit. The print head 19 according to this embodiment is a thermal head having a structure in which a plurality of heating elements is aligned. The print head 19 prints on the sheet of paper LP sandwiched between the platen roller 17 and the print head 19 by causing the heating element corresponding to the print pattern to generate heat. The print head 19 is biased against the platen roller 17 by a bias mechanism (not shown). As a result, in the printer 1, the print head 19 abuts on the platen roller 17.

The cutter 23 is positioned between the paper output port 11 and the print head 19, specifically, immediately before the paper output port 11 in the conveying direction of the sheet of paper LP. The cutter 23 cuts the leading edge portion of the sheet of paper LP output from the paper output port 11. The cutter 23 cuts the sheet of paper LP conveyed by the conveying mechanism such as the platen roller 17. Specifically, the cutter 23 includes a movable blade 231 and a fixed blade 233.

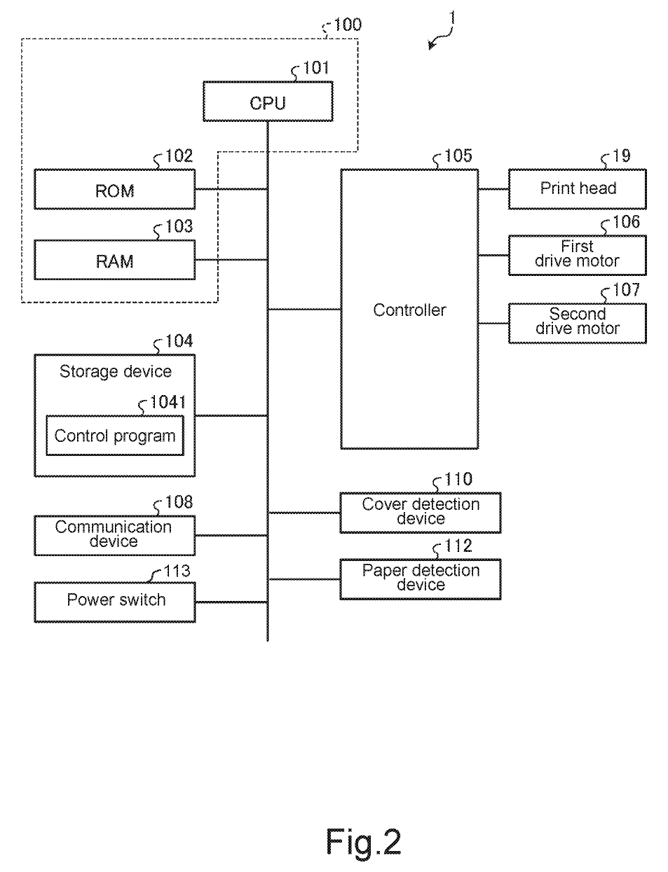

The movable blade 231 is a blade capable of moving in the thickness direction of the sheet of paper. The movable blade 231 moves vertically by a moving mechanism for moving the blade under control of a main controller 100 (see FIG. 2) described below mounted on the printer 1. In the following description, the main controller 100 will be referred to simply as the controller 100 in some cases. The fixed blade 233 is provided at a position facing the movable blade 231. When printing on the sheet of paper LP is finished, the movable blade 231 moves from the rear side of the sheet of paper to the front side of the sheet of paper, and the sheet of paper LP is cut by being sandwiched between the moved movable blade 231 and the fixed blade 233. The front side of the sheet of paper LP corresponds to, for example, the print surface of the sheet of paper. Further, the rear side of the sheet of paper LP corresponds to the side (non-print surface) opposite to the print surface of the sheet of paper.

Note that the application of the cutter 23 is not limited to cutting the sheet of paper LP (full cut). For example, the cutter 23 is capable of performing a partial cut, which cuts only part of the sheet of paper LP. The full cut and partial cut are set in advance via an operation unit (not shown) in accordance with a user's instruction.

Note that a leading edge detection sensor that detects the leading edge position of the sheet of paper LP may be provided between the paper output port 11 and the print head 19. The leading edge detection sensor may also be referred to as a paper end sensor. The leading edge detection sensor an optical sensor or the like provided in the vicinity of the paper output port 11 inside the main body 20 and detects the end of the sheet of paper.

Next, the hardware configuration of the printer 1 will be described with reference to FIG. 2. FIG. 2 is a diagram showing an example of the hardware configuration of the printer 1.

As shown in FIG. 2, the printer 1 includes a central processing unit (CPU) 101, a read only memory (ROM) 102, and a random access memory (RAM) 103.

The CPU 101 is an example of a processor and serves as the control core of the printer 1. The ROM 102 stores various programs. The RAM 103 develops programs and various types of data. The CPU 101, the ROM 102, and the RAM 103 are connected via a bus or the like. The CPU 101, the ROM 102, and the RAM 103 constitute the controller 100. That is, the controller 100 executes control processing according to the operation of the printer 1 by the CPU 101 operating in accordance with a control program 1041 that is stored in the ROM 102 and a storage device 104 described below and developed into the RAM 103.

The storage device 104 includes a non-volatile memory such as a hard disc drive (HDD) and a flash memory in which stored information is retained even when the power source is turned off, e.g., even when a power switch 113 is turned OFF. The storage device 104 stores the control program 1041 for controlling the operation of the printer 1. Further, the storage device 104 stores various types of setting information relating to the operation of the printer 1.

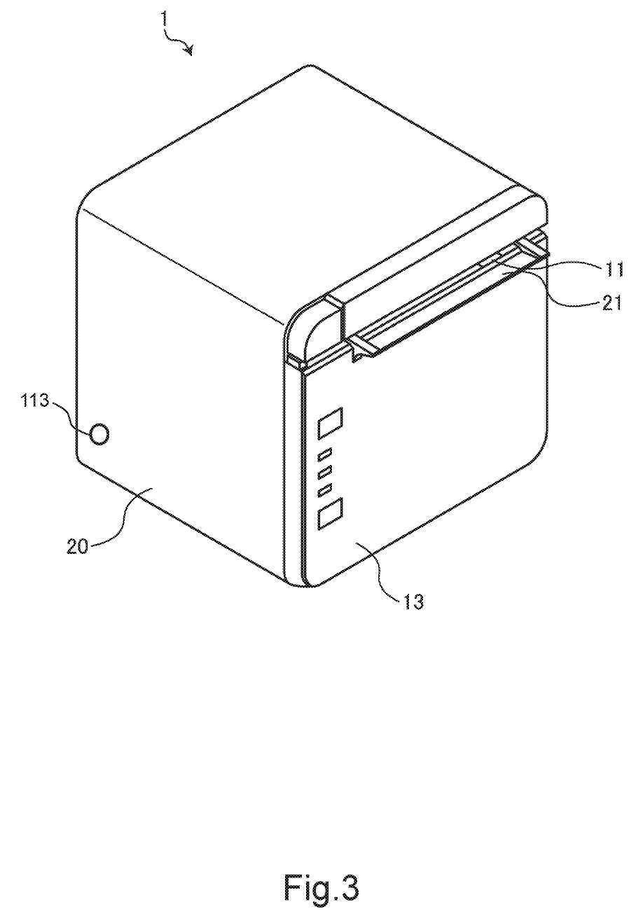

The storage device 104 stores a first predetermined amount and a second predetermined amount. The first predetermined amount is, for example, longer than the thickness of the cover 13. Specifically, in the case where a support member 21 is provided to the paper output port 11 of the cover 13, the first predetermined amount is a length that allows the sheet of paper LP to be held by a user relative to the support member 21 (see FIG. 3, also referred to as a table) and longer than the length of the support member 21 in a direction in which the sheet of paper LP is output (hereinafter, referred to as a support member length). That is, the first predetermined amount is a length that allows the leading edge portion of the cut sheet of paper LP to be held and longer than the length of the support member 21 along the direction in which the sheet of paper LP is output. Note that the first predetermined amount may be appropriately set in accordance with the type of support member 21. Further, the first predetermined amount may also be stored in the storage device 104 as a correspondence table of support member lengths corresponding to the type of support member 21.

The second predetermined amount is shorter than the first predetermined amount. The second predetermined amount is, for example, longer than the length of the cover 13 along the direction in which the sheet of paper is output (hereinafter, referred to as a cover length). The second predetermined amount is appropriately set in accordance with the cover length. From these facts, each of the first predetermined amount and the second predetermined amount corresponds to the length that allows the sheet of paper LP cut by the cutter 23 (specifically, the leading edge portion of the cut sheet of paper) to be held by a user.

The controller (main controller) 100 is connected via a bus or the like to a drive controller 105 that controls data input/output. In the following description, the drive controller 105 will be referred to simply as a controller 105 in some cases. The above-mentioned print head 19, a first drive motor 106, a second drive motor 107, and the like are connected to the controller 105.

The first drive motor 106 is a drive source of the platen roller 17. The first drive motor 106 is an example of a first drive unit. The first drive motor 106 is realized by, for example, a DC motor (Direct-current motor). Here, the first drive motor 106 functions as an example of a conveying mechanism (conveying unit) that conveys the sheet of paper LP in the feed direction (forward direction), together with the above-mentioned platen roller 17.

The second drive motor 107 is a drive source of the cutter 23. The second drive motor 107 is provided in a moving mechanism that causes the movable blade 231 in the cutter 23 to move. The second drive motor 107 is an example of a second drive unit. The second drive motor 107 is realized by, for example, a DC motor.

The controller (drive controller) 105 receives an instruction from the controller (main controller) 100 to control the operation of the respective units of the printer 1. For example, the controller 105 controls the operation of the first drive motor 106 to feed the sheet of paper LP at a predetermined conveying speed.

Further, the controller 100 is connected to a communication device 108 via a bus or the like. The communication device 108 communicates with an external device such as an information processing apparatus via a communication line (not shown). For example, the communication device 108 acquires print data to be printed on the sheet of paper LP from the external device or acquires print instructions. The communication line may be either a wired communication line or a wireless communication line.

The controller (main controller) 100 is connected to a cover detection device 110 via a bus or the like. The controller 100 outputs, to the controller (drive controller) 105, an instruction to operate the conveying mechanism such as the platen roller 17 and the cutter 23 in accordance with a signal output from the cover detection device 110.

Note that the hardware configuration of the printer 1 is not limited to the configuration shown in FIG. 2. For example, the printer 1 may include an operation unit for receiving a user's operation, a display unit that displays various types of information, and the like.

Further, the controller 100 is connected to a paper detection device 112 via a bus or the like. For example, the controller 100 causes, in the case where a signal relating to undetection of the sheet of paper LP is output from the paper detection device 112, a display unit (not shown) to display that the sheet of paper LP has not been detected. At this time, the controller 100 may cause a speaker (not shown) to output a predetermined sound. Further, in the case where a signal relating to detection of the sheet of paper LP is output from the paper detection device 112, for example, the controller 100 may cause the display unit (not shown) to display that a sheet of paper has been detected.

The controller 100 is capable of setting the output operation of outputting the sheet of paper LP housed in the printer 1 by the first predetermined amount to be disabled, in accordance with the turning on of the power source of the printer 1, e.g., in accordance with the ON state of the power switch 113. That is, the controller 100 sets the output operation of outputting the sheet of paper LP from the paper output port 11 by the first predetermined amount to be enabled or disabled, in accordance with a user's instruction. The controller 100 that sets the output operation to be enabled or disabled corresponds to a setting unit.

For example, in the case where the printer 1 is installed in 24-hour convenience stores or the like, the power source of the printer 1 remains in the ON state in some cases. In such cases, the controller 100 may be set to cause the output operation to be disabled, in accordance with a user's instruction. In the case where the output operation is set to be disabled, the conveying mechanism (e.g., the platen roller 17) does not execute the outputting of the sheet of paper LP by the first predetermined amount.

The cover detection device 110 is provided inside the main body 20. The cover detection device 110 detects the opened/closed state of the cover 13 on the printer 1. For example, the cover detection device 110 is a sensor (also referred to as a cover open sensor) that detects the opening/closing of the cover 13 of the printer 1 during replenishment of sheets of paper, or the like.

The cover detection device 110 is realized by, for example, a photodetector or a contact sensor. The cover detection device 110 outputs, when the closing of the cover 13 is detected, a signal relating to the detection of the closing (hereinafter, referred to as a cover closing detection signal) to the controller 100.

The paper detection device 112 is a sensor that detects the presence or absence of the sheet of paper LP. The paper detection device 112 is realized by, for example, a contact sensor or a photodetector. For example, the paper detection device 112 detects the sheet of paper LP by the contact of the end portion of an arm capable of rotating upon contact with the sheet of paper LP (hereinafter, referred to as a paper sensor arm) with the contact sensor or by blocking of light in the photodetector. The paper detection device 112 outputs, when a sheet of paper is detected, a signal relating to the detection of the sheet of paper (hereinafter, referred to as a paper detection signal) to the controller 100.

Next, the appearance, configuration, and the like of the printer 1 will be described with reference to FIG. 3. FIG. 3 is a diagram showing an example of the appearance of the printer 1 in the case where the paper output port 11 through which the sheet of paper cut by the cutter 23 is output is horizontal. In FIG. 3, the printed sheet of paper LP is output horizontally from the printer 1.

FIG. 4 is a diagram showing an example of the printer 1 shown in FIG. 3 with the cover 13 opened. As shown in FIG. 4, the rolled paper LR obtained by winding the sheet of paper LP is housed. Further, the platen roller 17 is mounted on the cover 13. At this time, the print head 19 is located on the main body (casing) 20 side of the printer 1. Note that the positional relationship between the platen roller 17 and the print head 19 is not limited to the one shown in FIG. 4. The print head 19 may be mounted on the cover 13, and the platen roller 17 may be placed in the main body 20 of the printer 1.

In the case where the printer 1 is installed as shown in FIGS. 3 and 4, the front side may be expressed as the upper side and the rear side may be expressed as the lower side. Note that the printer 1 is not limited to the one shown in FIG. 1, and may be installed, for example, such that the paper output port 11 faces upward in the vertical direction. In order to make the description more specific, the printer 1 installed such that the paper output port 11 is horizontal will be described below.

As shown in FIGS. 3 and 4, the support member 21 is provided to the paper output port 11 of the cover 13 of the printer 1. The support member 21 supports the sheet of paper output from the paper output port 11 from the rear side. The support member 21 is attachably/detachably provided to/from the paper output port 11. That is, the support member 21 is attachably/detachably formed on the cover 13. The support member 21 that supports the sheet of paper from the rear side may also be referred to as a table.

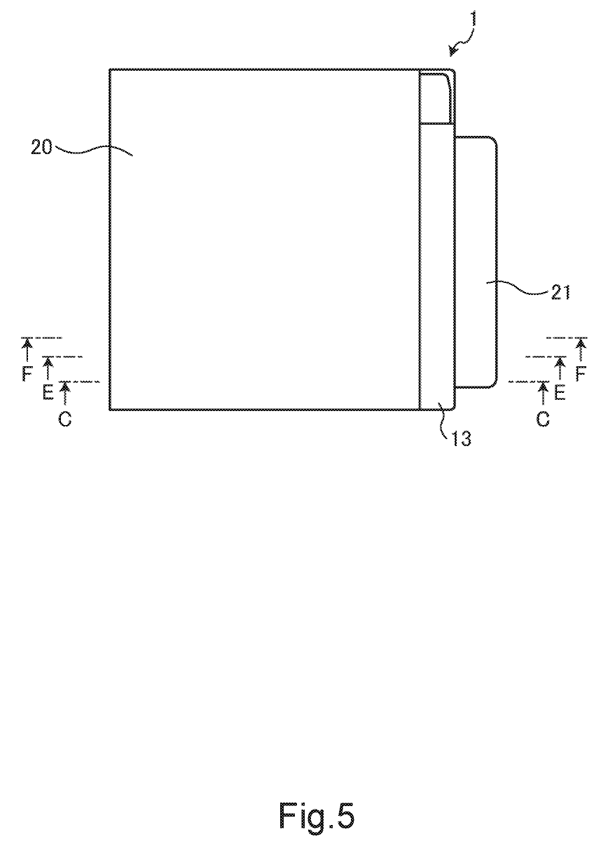

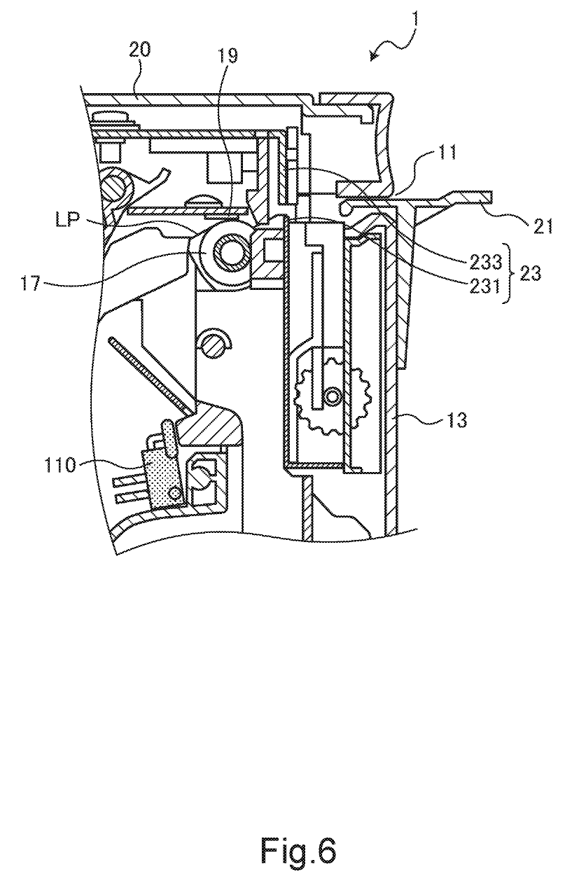

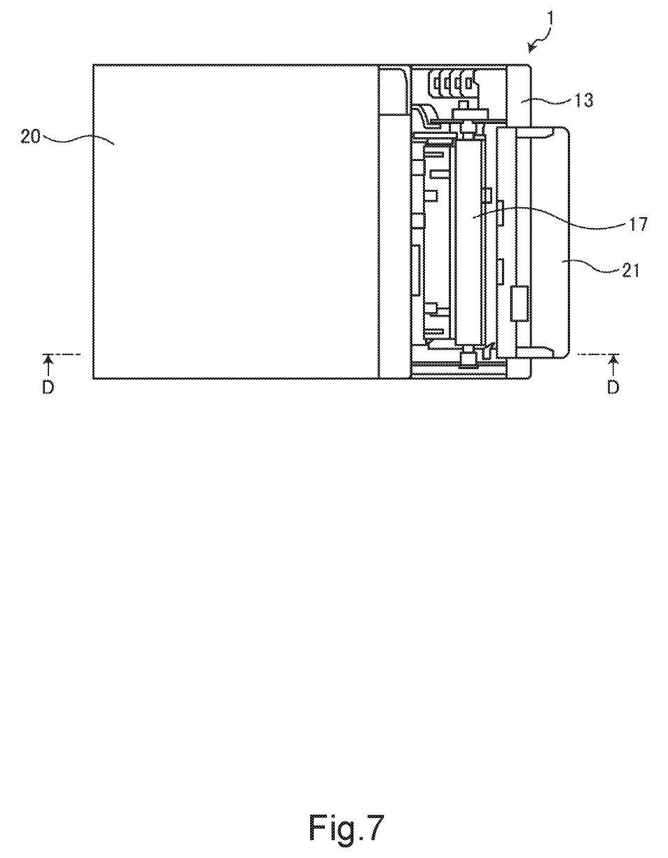

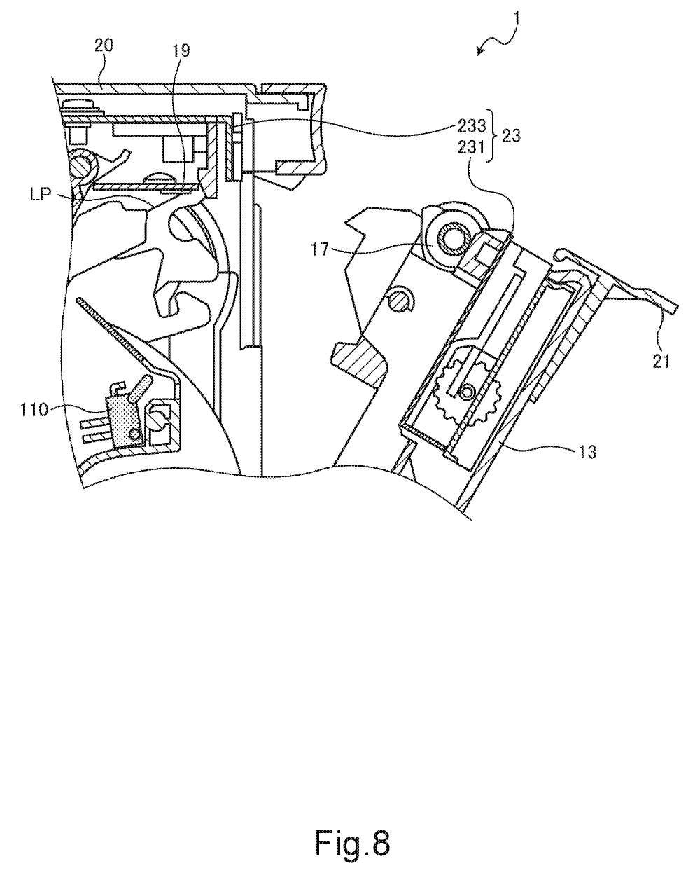

FIG. 5 is a top view of the printer 1 with the cover 13 closed. FIG. 6 is an enlarged view of the cross section of the printer 1 shown in FIG. 5 taken along the arrow C-C. FIG. 7 is a top view of the printer 1 with the cover 13 opened. FIG. 8 is an enlarged view of the cross section of the printer 1 shown in FIG. 7 taken along the arrow D-D.

As shown in FIGS. 6 and 8, the cover detection device 110 is realized by, for example, a mechanical switch. The switch of the cover detection device 110 is pressed and turned on, for example, when the cover 13 is closed against the lower part of the main body 20. In this way, the cover detection device 110 detects that the cover 13 is closed against the lower part of the main body 20.

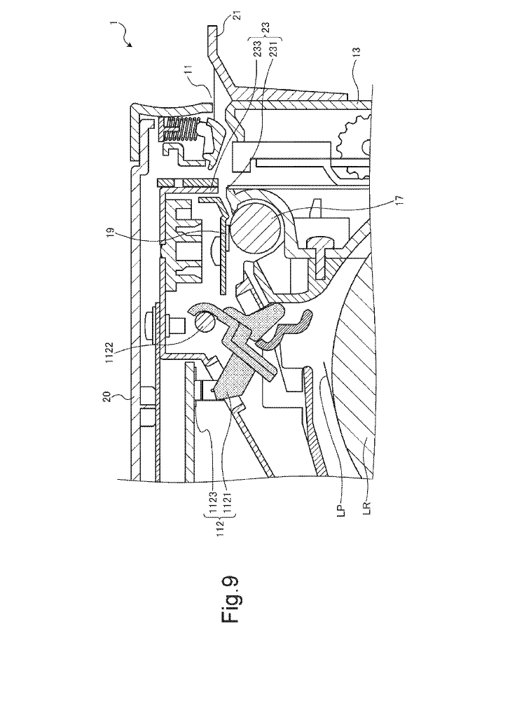

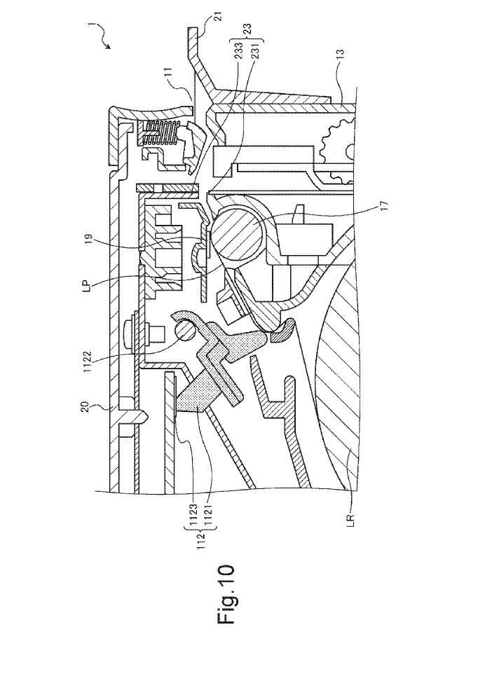

FIG. 9 is an enlarged view of the cross section of the printer 1 shown in FIG. 5 taken along the arrow E-E. FIG. 10 is an enlarged view of the cross section of the printer 1 shown in FIG. 5 taken along the arrow F-F. As shown in FIG. 9, a paper sensor arm 1121 is connected to the main body 20 of the printer 1 via a rotation shaft 1122. That is, the paper sensor arm 1121 is mounted on the main body 20 so as to be rotatable about the rotation shaft 1122. As shown in FIG. 9, one end of the paper sensor arm 1121 is not in contact with the sheet of paper LP.

For this reason, the other end of the paper sensor arm 1121 does not reach a sensor 1123. That is, the other end of the paper sensor arm 1121 is not in contact with the contact sensor or does not block light in the photodetector. At this time, the paper detection device 112 outputs, to the controller 100, a signal indicating that the sheet of paper LP has not been detected (hereinafter, referred to as a paper undetection signal).

As shown in FIG. 10, one end of the paper sensor arm 1121 is in contact with the sheet of paper LP. The contact between the one end of the paper sensor arm 1121 and the sheet of paper LP causes the paper sensor arm 1121 to rotate about the rotation shaft 1122. As a result, the other end of the paper sensor arm 1121 reaches the sensor 1123. That is, the other end of the paper sensor arm 1121 is in contact with the contact sensor or blocks light in the photodetector. As a result, the paper detection device 112 outputs the paper detection signal to the controller 100.

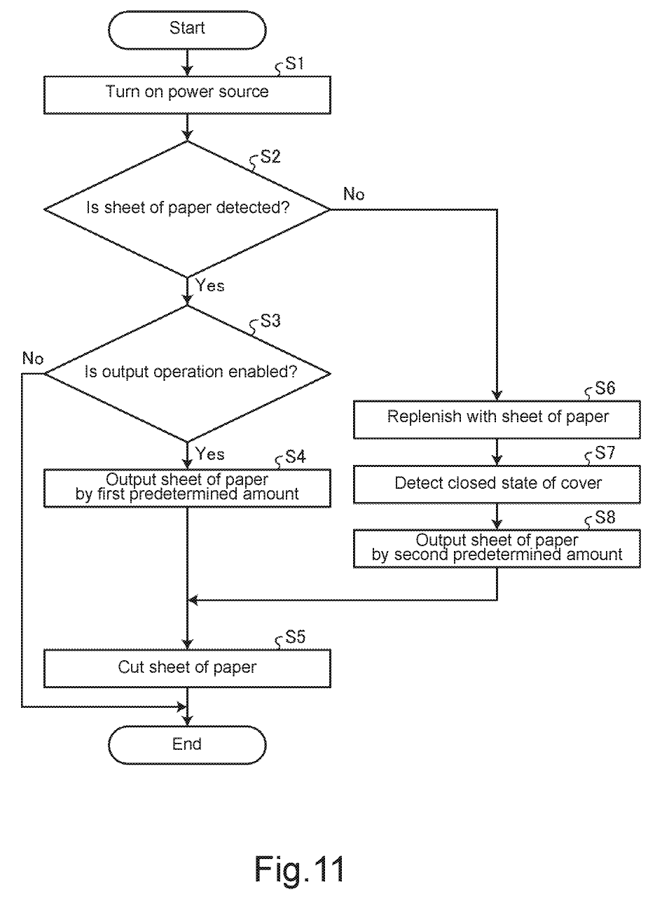

Next, an operation example of the printer 1 relating to auto-feed and cut will be described with reference to FIG. 11. FIG. 11 is a flowchart showing an example of the operation flow of auto-feed and cut performed by the printer 1. In the operation of auto-feed and cut according to this embodiment, assumption is made that the power source of the printer 1 is turned off in advance, i.e., in the power OFF state.

### Auto-feed and cut

### Step S1

The power source of the printer 1 is turned on by a user's operation. For example, the power source the printer 1 is turned on by switching the power switch 113 provided to the main body 20 of the printer 1 from the OFF state to the ON state.

### Step S2

The paper detection device 112 detects the presence or absence of a sheet of paper housed inside the main body 20 of the printer 1. When the sheet of paper is detected by the paper detection device 112 (Yes in Step S2), the processing of Step S3 is executed. When the sheet of paper is not detected by the paper detection device 112 (No in Step S2), the processing of Step S6 is executed.

### Step S3

In accordance with the turning on of the power source, e.g., in accordance with the ON state of the power switch 113, whether or not the output operation of outputting the sheet of paper LP by the first predetermined amount has been set by the controller 100 is determined. In the case where the output operation of outputting the sheet of paper LP by the first predetermined amount is enabled (Yes in Step S3), the processing of Step S4 is executed. Further, in the case where the output operation of outputting the sheet of paper LP by the first predetermined amount is not enabled, i.e., the output operation is disabled (No in Step S3), the processing of auto-feed and cut ends.

### Step S4

The controller (main controller) 100 outputs, to the controller (drive controller) 105, an instruction (signal) to output the sheet of paper from the paper output port 11 by the first predetermined amount. Subsequently, the controller 105 drives the first drive motor 106. As a result, the platen roller 17 rotates by an amount corresponding to the first predetermined amount, and the sheet of paper LP is output toward the paper output port 11 by the first predetermined amount from the paper output port 11. In this way, the conveying mechanism outputs the sheet of paper LP from the paper output port 11 by the first predetermined amount. The output of the sheet of paper LP over the first predetermined amount can be detected by, for example, the leading edge detection sensor.

### Step S5

When the sheet of paper LP is conveyed toward the paper output port 11 by the first predetermined amount, the controller (main controller) 100 outputs, to the controller (drive controller) 105, an instruction (signal) to cut the sheet of paper LP. Subsequently, the controller 105 drives the second drive motor 107. The driving of the second drive motor 107 causes the cutter 23 to operate to cut the sheet of paper LP. As a result, the cutter 23 cuts the leading edge portion of the sheet of paper LP output from the paper output port 11. The cut sheet of paper is held by the user and removed from the printer 1.

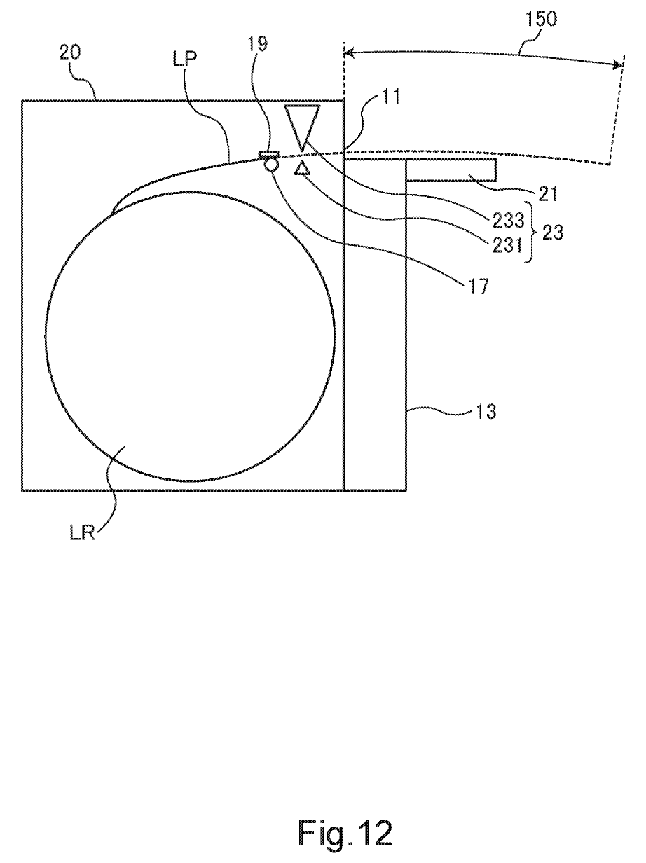

FIG. 12 is a diagram showing an example of the state where, after the power source of the printer 1 is turned ON, the sheet of paper LP is conveyed by a first predetermined amount 150 and cut by the cutter 23. As shown in FIG. 12, the sheet of paper LP is output from the paper output port 11 by the first predetermined amount. As shown in FIG. 12, the sheet of paper LP is conveyed by the first predetermined amount 150 and cut by the cutter 23. As shown in FIG. 12, the user can easily remove the cut sheet of paper from the printer 1. For example, in the case where the distance from the cutter 23 to the tip of the cover 13 is 10 mm and the support member length is 15 mm, the first predetermined amount 150 is set to 40 mm. At this time, according to this embodiment, a holding part of 15 mm can be provided.

After Step S5, the sheet of paper LP is rewound (reverse-conveyed) in the direction opposite to the output direction of the sheet of paper LP. For example, in the case where the print position is 4 mm from the leading edge of the sheet of paper LP, the conveying mechanism conveys the sheet of paper LP such that the print head 19 is located 4 mm from the leading edge of the sheet of paper LP.

### Step S6

The cover 13 is opened by the user, and the printer 1 is replenished with the rolled paper LR. At this time, the leading edge of the rolled paper LR is sandwiched between the platen roller 17 and the print head 19, and the leading edge of the sheet of paper protrudes from the printer 1. Thus, the cover 13 is closed.

### Step S7

When the cover 13 is closed, the cover detection device 110 detects the closed state of the cover 13. At this time, the cover detection device 110 outputs the cover closing detection signal to the controller 100. Further, the paper detection device 112 detects the sheet of paper LP. The paper detection device 112 outputs the paper detection signal to the controller 100.

### Step S8

The controller (main controller) 100 outputs, to the controller (drive controller) 105, an instruction (signal) to convey the sheet of paper by the second predetermined amount from the paper output port 11. Subsequently, the controller 105 drives the first drive motor 106. As a result, the platen roller 17 rotates by an amount corresponding to the second predetermined amount, and the sheet of paper LP is conveyed toward the paper output port 11 by the second predetermined amount.

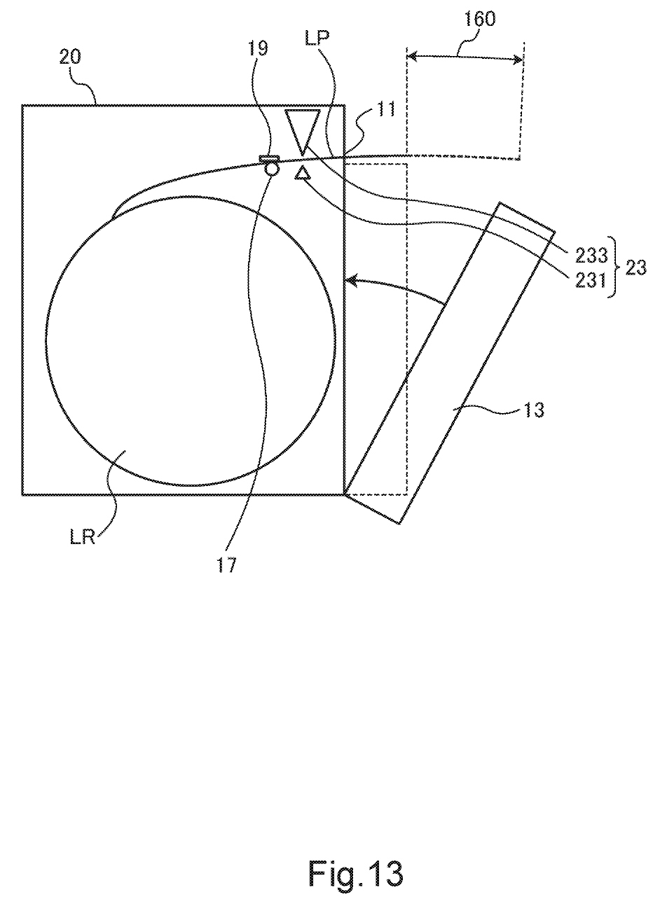

FIG. 13 is a diagram showing an example of the state where, after the rolled paper LR is loaded, the sheet of paper LP is conveyed by a second predetermined amount 160 and cut by the cutter 23. As shown in FIG. 13, the sheet of paper LP is output from the paper output port 11 by the second predetermined amount. FIG. 13 shows an example in which the support member 21 is not mounted. As shown in FIG. 13, when the cover 13 is closed, the sheet of paper LP is conveyed by the second predetermined amount 160 and cut by the cutter 23. The second predetermined amount 160 is, for example, 10 mm. As a result, as shown in FIG. 13, the user can easily remove the cut sheet of paper from the printer 1.

As described above, the printer 1 according to this embodiment detects the sheet of paper LP in accordance with the turning on of the power source, e.g., in accordance with the ON state of the power switch 113, conveys the sheet of paper LP toward the paper output port 11 from which the sheet of paper LP is output in accordance with the detection of the sheet of paper LP, outputs the sheet of paper LP from the paper output port 11 by the first predetermined amount 150, cuts the leading edge portion of the sheet of paper LP output from the paper output port 11, detects that the cover 13 provided to the paper output port 11 has transitioned from the opened state to the closed state, conveys the sheet of paper LP toward the paper output port 11 in accordance with the detection that the cover 13 has transitioned from the opened state to the closed state, and outputs the sheet of paper LP from the paper output port 11 by the second predetermined amount 160 shorter than the first predetermined amount 150.

As a result, according to the printer 1 according to this embodiment, when the power source is turned ON, the sheet of paper LP can be conveyed by the first predetermined amount 150 longer than the second predetermined amount 160 and cut, and the sheet of paper LP can be conveyed by the second predetermined amount 160 in accordance with the transition of the cover 13 from the opened state to the closed state and cut. For this reason, according to the printer 1 according to this embodiment, in both cases where the cover 13 is closed and the power source is turned ON, the leading edge of the sheet of paper LP can be cut and the cut sheet of paper can be removed.

Further, the second predetermined amount 160 in the printer 1 according to this embodiment is longer than the length of the cover 13 along the direction in which the sheet of paper LP is output. As a result, according to the printer 1 according to this embodiment, it is possible to cut the leading edge of the sheet of paper LP while the cover 13 is closed and easily remove the cut sheet of paper.

Further, the printer 1 according to this embodiment further includes the support member 21 that is provided to the paper output port 11 and supports the sheet of paper LP output from the paper output port 11 from the rear side, and the first predetermined amount 150 in the printer 1 according to this embodiment is a length that allows the leading edge portion of the sheet of paper LP to be held and longer than the length of the support member 21 along the direction in which the sheet of paper LP is output. As a result, according to the printer 1 according to this embodiment, it is possible to cut the leading edge of the sheet of paper LP while the power source of the printer 1 on which the support member 21 is mounted is in the ON state, and easily remove the cut sheet of paper.

Further, the printer 1 according to this embodiment is capable of setting the output operation of outputting the sheet of paper LP by the first predetermined amount 150 to be disabled, in accordance with the turning on of the power source, e.g., in accordance with the ON state of the power switch 113, and does not execute, in the case where the output operation is set to be disabled, the outputting of the sheet of paper LP by the first predetermined amount 150. As a result, according to the printer 1 according to this embodiment, it is possible to set the operation of auto-feed and cut during the power source is in the ON state to be disabled and reduce the power consumption of the printer 1 in stores where the power source is constantly in the ON state.

Further, each of the first predetermined amount 150 and the second predetermined amount 160 in the printer 1 according to this embodiment corresponds to a length that allows the sheet of paper cut by the cutter 23 to be held. As a result, it is possible to cut the leading edge of the sheet of paper LP and easily remove the cut sheet of paper in both cases where the cover 13 is closed and the power source is turned ON.

From the above, according to the printer 1 according to this embodiment, it is possible to avoid printing defects after the power source is turned on. In addition, according to the printer 1 according to this embodiment, it is possible to save the sheet of paper LP (environmentally-friendly) by reducing the margin (top margin) during printing through the backfeed of the cut sheet of paper LP. Further, according to the printer 1 according to this embodiment, it is possible to confirm that the rolled paper LR is housed the printer 1 without opening/closing the cover 13 when the power source of the printer 1 is turned on, thereby improving the user's work efficiency.

### Modification

The auto-feed and cut realized by the printer 1 according to the embodiment may be realized by a program. The program causes a computer to execute the processing of detecting the sheet of paper LP in accordance with the turning on of the power source, the processing of conveying the sheet of paper LP toward the paper output port 11 from which the sheet of paper LP is output in accordance with the detection of the sheet of paper LP and outputting the sheet of paper LP from the paper output port 11 by the first predetermined amount 150, the processing of cutting the leading edge portion of the sheet of paper LP output from the paper output port 11, the processing of detecting that the cover 13 provided to the paper output port 11 has transitioned from the opened state to the closed state, and the processing of conveying the sheet of paper LP toward the paper output port 11 in accordance with the detection that the cover 13 has transitioned from the opened state to the closed state and outputting the sheet of paper LP from the paper output port 11 by the second predetermined amount 160 shorter than the first predetermined amount 150.

For example, the processing of auto-feed and cut can also be realized by installing a program on an existing POS terminal and developing the program in a memory. In this case, the program capable of causing the computer to execute the processing may be stored in a non-volatile recording medium such as a magnetic disc (e.g., a hard disk), an optical disc (e.g., CD-ROM or DVD), and a semiconductor memory and distributed.

Further, the program does not necessarily need to be distributed by being stored in a non-volatile recording medium and may be distributed using a telecommunication function, e.g., downloaded via the Internet. The processing procedure in the program conforms to the auto-feed and cut according to the embodiment. Further, the effect achieved by the program are similar to those in the embodiment. For this reason, the description of the processing procedure and effect of the auto-feed and cut in the program is omitted.

According to the embodiment and the like described above, it is possible to provide the printer 1 from which the cut portion can be easily removed, when the power source of the printer 1 is turned on, e.g., when the power switch 113 is in the ON state.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A printer that prints on a sheet of paper housed inside a main body having an openable/closable cover and outputs the sheet of paper from an output port of the main body, comprising:
a paper detection device configured to detect presence or absence of the sheet of paper housed inside the main body;
a conveying mechanism configured to transport the sheet of paper in a direction in which the sheet of paper is output from the discharge port;
a cover detection device configured to detect an opened/closed state of the cover; and
a controller configured to
determine whether or not the sheet of paper is detected by the paper detection device when power is turned on,
control, where the sheet of paper is detected as a result of the determination, the conveying mechanism to execute a first output operation of outputting the sheet of paper from the output port by a first predetermined amount, and
control, where the cover detection device detects that the cover has transitioned from the opened state to the closed state, the conveying mechanism to execute a second output operation of outputting the sheet of paper from the output port by a second predetermined amount, the second predetermined amount being shorter than the first predetermined amount.

2. The printer according to claim 1, wherein
the main body is replenishable with the sheet of paper while the cover is in the opened state.

3. The printer according to claim 1, wherein
the paper detection device outputs a paper detection signal indicating that the sheet of paper has been detected,
the cover detection device outputs a cover detection signal indicating that the cover has transitioned from the opened state to the closed state, and
the controller further includes a main controller and a drive controller, the main controller being connected to the paper detection device and the cover detection device, the drive controller being connected to the conveying mechanism,
the main controller being configured to
instruct, where the cover detection signal is received from the paper detection device, the drive controller to execute the first output operation, and
instruct, where the cover detection signal is received from the cover detection device, the drive controller to execute the second output operation,
the drive controller being configured to control the conveying mechanism in accordance with the instruction from the main controller.

4. The printer according to claim 1, wherein
the second predetermined amount is longer than a length of the cover along a direction in which the sheet of paper is output.

5. The printer according to claim 1, further comprising
a support member that is provided to the output port and
supports the sheet of paper output from the output port from a rear side,
the first predetermined amount being a length that allows a leading edge portion of the sheet of paper to be held and longer than a length of the support member along a direction in which the sheet of paper is output.

6. The printer according to claim 1, wherein
the controller is further configured to be capable of setting the first output operation to be disabled in accordance with a user's instruction.

7. The printer according to claim 6, wherein
the controller is further configured to prevent, where the first output operation has been set to be disabled, the conveying mechanism from executing the first output operation.

8. The printer according to claim 1, further comprising
a cutter that cuts a leading edge portion of the sheet of paper output from the output port.

9. The printer according to claim 8, wherein
each of the first predetermined amount and the second predetermined amount corresponds to a length that allows the sheet of paper cut by the cutter to be held.

10. A control method for a printer that prints on a sheet of paper housed inside a main body having an openable/closable cover and outputs the sheet of paper from an output port of the main body, comprising:
determining whether or not the sheet of paper housed inside the main body is detected by a paper detection device when power is turned on;
controlling, where the sheet of paper is detected as a result of the determination, a conveying mechanism for the sheet of paper to execute a first output operation of outputting the sheet of paper from the output port by a first predetermined amount; and
controlling, where a cover detection device detects that the cover has transitioned from an opened state to a closed state, the conveying mechanism to execute a second output operation of outputting the sheet of paper from the output port by a second predetermined amount, the second predetermined amount being shorter than the first predetermined amount.
